(19) United States
(12) Patent Application Publication
(10) Pub. No.: US 2022/0089332 A1
(43) Pub. Date: Mar. 24, 2022

(54) FOOD DISPENSING DEVICE

(71) Applicant: TRUDEAU CORPORATION 1889 INC., Boucherville (CA)

(72) Inventor: JEAN-CHARLES VIANCIN, HONG-KONG (CN)

(21) Appl. No.: 17/539,953

(22) Filed: Dec. 1, 2021

Related U.S. Application Data
(63) Continuation of application No. 16/739,473, filed on Jan. 10, 2020, now abandoned.
Application No. 16/739,473 is a continuation of application No. 16/224,971, filed on Dec. 19, 2018, now abandoned.
(60) Provisional application No. 62/607,568, filed on Dec. 19, 2017.

(51) Int. Cl. B65D 35/38; B65D 35/12; A23G 3/28; A21C 15/00

(52) U.S. Cl. CPC B65D 35/38; A21C 15/005; A23G 3/28; B65D 35/12

(57) ABSTRACT

A food dispensing device that manually operates for applying pressure on a flexible container to release a food preparation, for example icing or filling, on a desired surface, for example on cakes, cupcakes, pastries or cookies.

### FIELD OF THE INVENTION

The present disclosure relates to a dispenser for semi-solid foods, such as a pastry bag.

### BACKGROUND OF INVENTION

There have been many devices conceived to ease the making and to allow creative design of semi-solid foods, such as pastries. A common example of such device is a pastry bag, which eases the disposal of fluid on meals, for example icing on cakes. Typical pastry bags are made of a disposable plastic bag comprising an aperture at one of its corner. The user fills the disposable plastic bag with the food product to be dispensed, then applies pressure to press out the food preparation from the aperture of the plastic bag, and after use throws away the plastic bag and the remains of the food product.

### SUMMARY OF THE INVENTION

According to one aspect, this disclosure relates to a food dispensing device comprising a bag for receiving a semi-solid food preparation; a connector permanently secured to the bag; and a dispensing tip releasably mounted to the connector. The bag has a wide opening at one end and a narrow opposite opening that is permanently secured to the connector. The wide opening is used to fill the bag with the food preparation, which is expressed through the connector to which the dispensing tip is mounted. Preferably, the connector and the bag are co-molded. They are made of plastic materials that are permanently jointed to each other to form a unitary structure. Different tips can thus be interchangeably used to dispense the food preparation in different shapes.

The dispensing tip can be mounted to the connector in different ways. One option is to use a bayonet connection. Another option is to use a threaded (screw-on) connection. The threaded connection can be adapted to accept dispensing tips used with prior art pastry bags.

### BRIEF DESCRIPTION OF THE DRAWINGS

A detailed description of embodiments of the invention is provided below, by way of example only, with reference to the accompanying drawings, in which:

FIGS. 1 and 2 show a perspective view and an exploded perspective view of a food dispensing device belonging to prior art;

FIG. 3 is a perspective view of a food-dispensing device according to a first embodiment of the present invention;

FIG. 4 is an exploded perspective view of the food dispensing device of FIG. 3;

FIG. 5 is a perspective view of a connector of the food dispensing device of FIG. 3;

FIG. 6 is a cross-sectional view illustrating the way the connector is secured to the bag of the food dispensing device of FIG. 3;

FIG. 7 is a cross-sectional view of a dispensing tip of the food dispensing device of FIG. 3.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

To facilitate the description, any reference numeral designating an element in one figure will designate the same element if used in any other figures. In describing the embodiments, specific terminology is resorted to for the sake of clarity but the invention is not intended to be limited to the specific terms so selected, and it is understood that each specific term comprises all equivalents.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure. Similarly, the terms “inwardly,” “outwardly” and “radially” generally refer to the orientation of a surface relative to its axis of elongation, or axis of rotation, as appropriate.

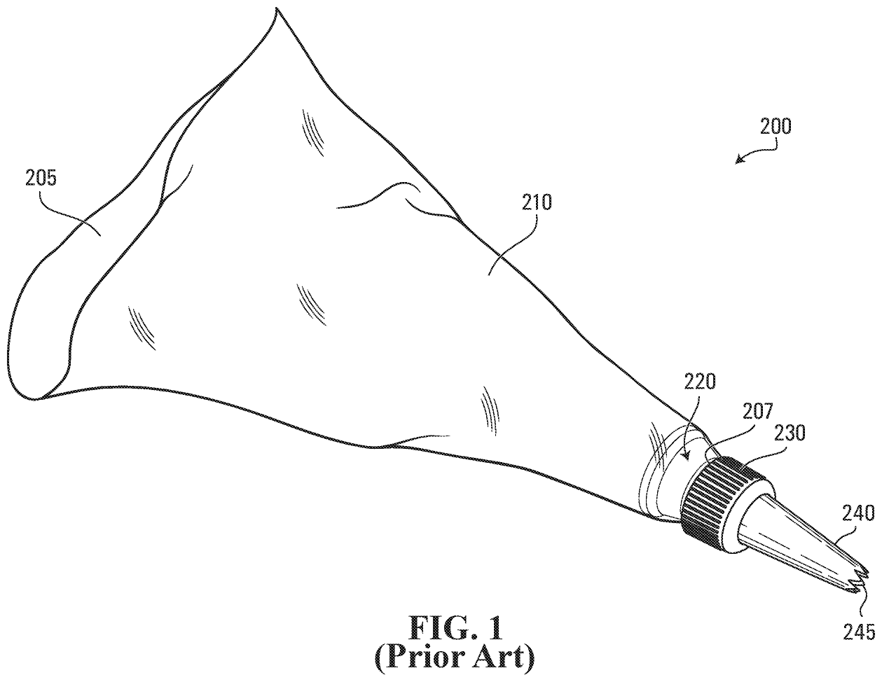

FIGS. 1 and 2 show a food dispensing device 200 belonging to prior art. This food dispensing device comprises a bag 210 for receiving a semi-solid food preparation, a dispensing tip 240 for dispensing the semi-solid food preparation, an inner connector 220 and an outer connector 230 that connect the bag 210 to the dispensing tip 240.

The bag 210 comprises a wide opening 205 used to fill the bag 210 with the semi-solid food preparation, and a narrow opposite opening 207. When the user closes the wide opening 205 (e.g. with a clip, with an elastic, with hands, etc.) and compresses the bag 210, the semi-solid food preparation enclosed in the bag 210 is expelled through the narrow opposite opening 207, through the inner and outer connectors 220 and 230 through the dispensing tip 240, and finally is extruded through an end 245 of the dispensing tip 240, giving the semi-solid food preparation a final shape.

When the outer connector 230 is screwed over the inner connector 220, the bag 210 and the dispensing tip 240 are secured between the inner and outer connectors 220 and 230.

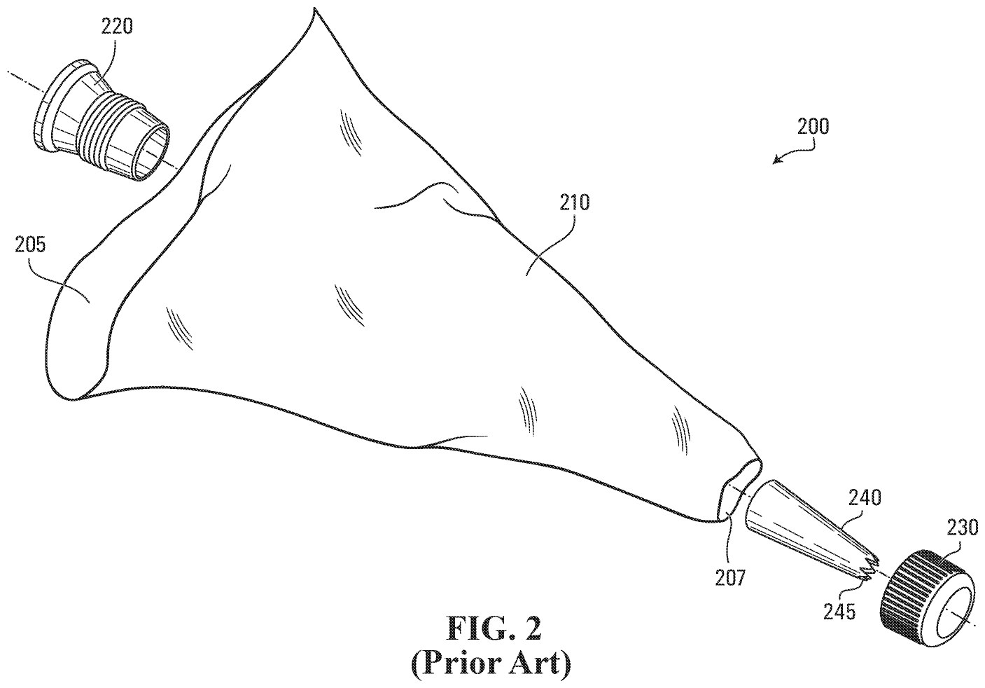

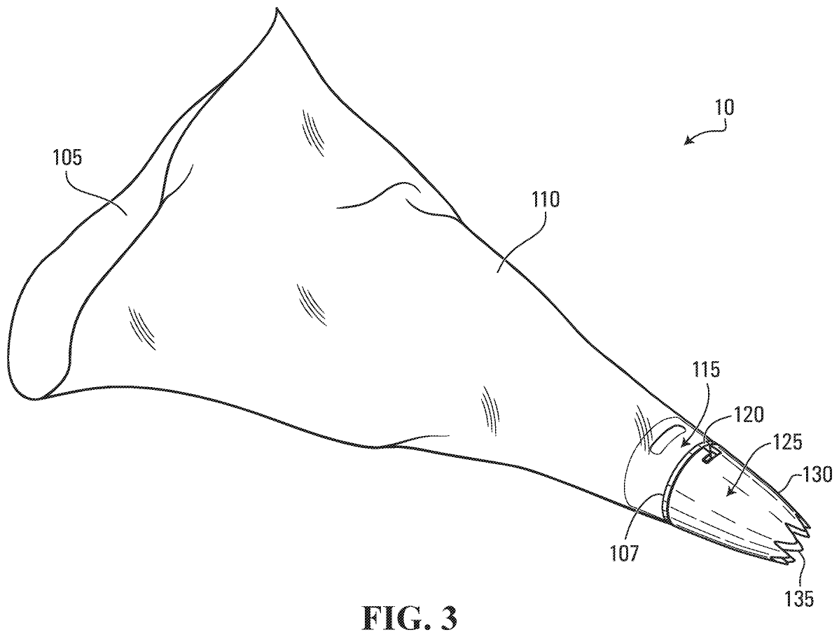

FIGS. 3 and 4 show a first embodiment of a food dispensing device 10 in accordance with the invention. In this embodiment, the food dispensing device 10 comprises a bag 110 configured to receive a semi-solid food preparation (e.g. icing for cakes and cupcakes, filling for pastries, etc.), a tip 130 that is a dispensing tip for dispensing the semi-solid food preparation, and a connector 120 permanently secured to the bag 110 and connecting the bag 110 to the tip 130.

The bag 110 comprises a wide opening 105 used to fill the bag 110 with the semi-solid food preparation, and a narrow opposite opening 107. When the user compresses the bag 110, the semi-solid food preparation circulates through the narrow opposite opening 107.

The bag 110 is made of a material facilitating the use of the food dispensing device 10 and allowing multiple uses. To this end, the material of the bag 110 is selected to facilitate cleaning. Additionally or alternatively, the material of the bag 110 may allow the bag 110 to be more or less rigid and/or more or less elastic. The material of the bag 110 may be hydrophobic. The material of the bag 110 may comprise a polymer. More specifically, in this embodiment, the material of the bag 110 comprises silicone. In other embodiments, the material of the bag 110 may comprise a fabric. In other embodiments, the material of the bag 110 may comprise a plastic-coated fabric.

The bag 110 has a thickness. In this embodiment, the thickness of the bag 110 is generally uniform and has a preferred value between 1 mm and 5 mm.

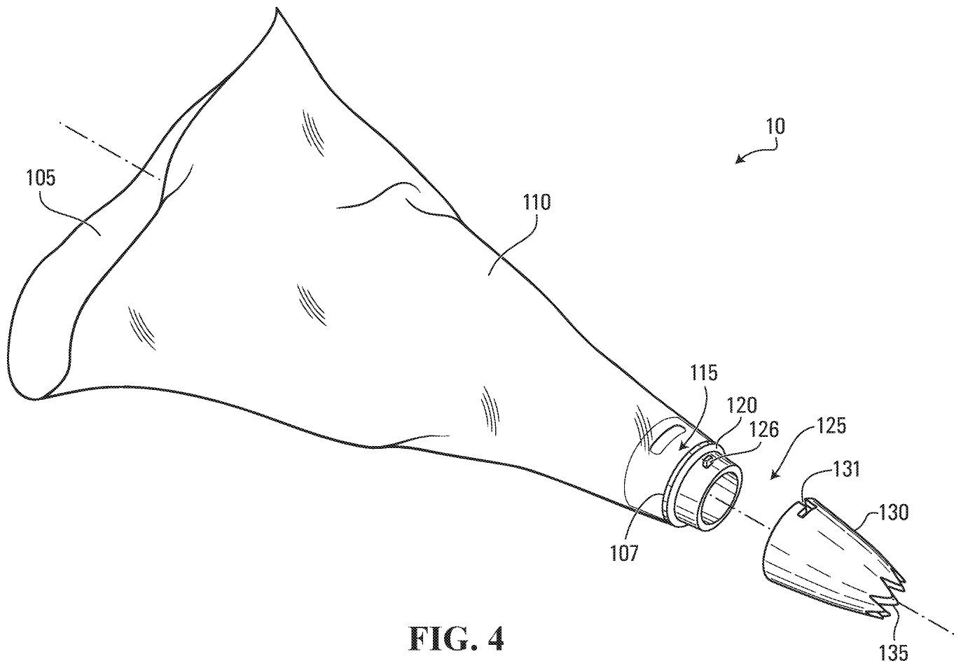

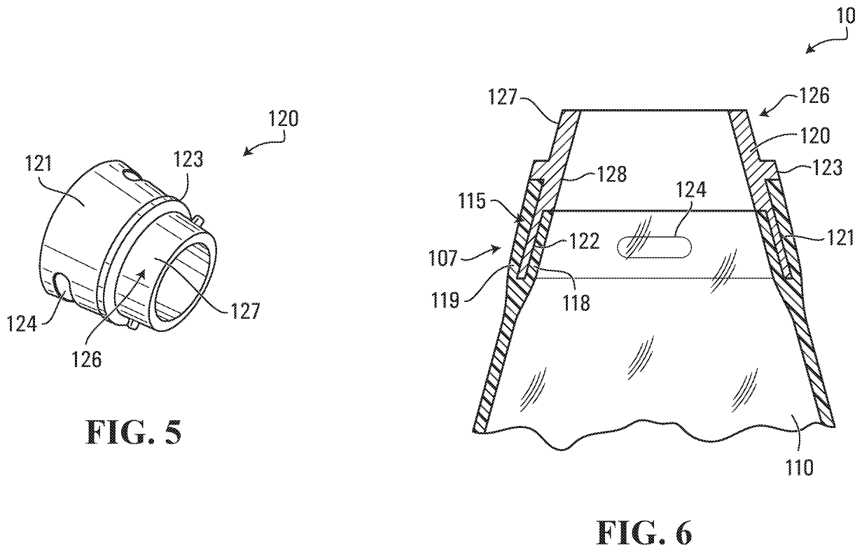

With additional reference to FIGS. 5 and 6, the bag 110 is permanently secured to the connector 120 by a connection 115 such that the bag 110 and the connector 120 form a unitary structure. In this embodiment, the connection 115 is made over an outer securing surface 121 and an inner securing surface 122 of the connector 120. More specifically, the bag 110 is co-molded with the outer and inner securing surfaces 121 and 122 of the connector 120. Near its lower extremity, the bag 110 comprises an inner layer 118 that is in contact with the inner securing surface 122 of the connector 120, and an outer layer 119 that is in contact with the outer securing surface 121 of the connector 120. In addition to the outer and inner securing surfaces 121 and 122, the connector 120 may comprise one or more holes 124 through which the outer and inner securing surfaces 121 and 122 join, providing further stability and/or durability to the connection 115. At the inner layer 118, the narrow opening 107 of the bag 110 abuts against a first ridge of the connector 120 and a thickness of the inner layer 118 is such that an inner surface of the inner layer 118 is flush with an inner surface 128 of the first ridge. Additionally or alternatively, the inner surface 128 of the first ridge may be at least generally frustoconical. At the outer layer 119, the narrow opening 107 of the bag 110 abuts a second ridge of the connector 120 and a thickness of the outer layer 119 is such that an outer surface of the outer layer 119 is flush with an outer surface 123 of the second ridge.

In other embodiments, the bag 110 may be secured to the connector 120 by other means, for example by being glued.

The connector 120 may be made of any suitable material. In some embodiments, the connector 120 may be made of a relatively rigid material to provide strength and/or durability. In some embodiments, the connector 120 may be made of a relatively rigid plastic. In this embodiment, the connector 120 is made of molded plastic material. In other embodiments, the connector 120 may be made of a metal (e.g. copper, stainless steel, aluminum, silver, gold, etc.).

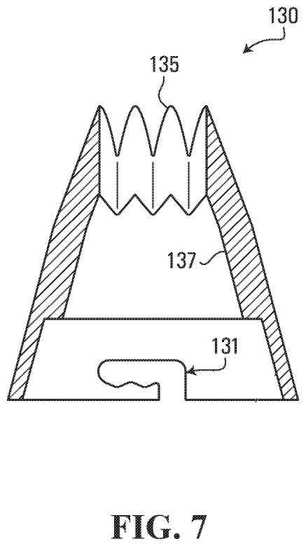

With additional reference to FIG. 7, the connector 120 is secured to the tip 130 by a second connection 125. In this embodiment, the second connection 125 includes a first mating element 126 that is part of the connector 120, and a second mating element 131 that is part of the tip 130. In this embodiment, the connection 125 allows at least part of an outer surface 127 of the connector 120 to be in contact with at least part of an inner surface of the tip 130, and the inner surface 128 of the first ridge of the connector 120 to be continuous with an inner surface 137 of the tip 130. Additionally or alternatively, the inner surface 137 of the tip 130 may be at least generally frustoconical. The tip 130 may be sold in a kit, separately, or be a part of another kit.

The connection 125 allows the tip 130 to be releasable and may be of any suitable kind. In this embodiment, the connection 125 is a bayonet connection: the first mating element 126 comprises two projections and the second mating element 131 comprises two apertures configured to house and secure the two projections of the first mating element 126 with a rotation by a pre-determined angle of the connector 120 relative to the tip 130. In other embodiments, the connection 125 may comprise a thread, clips, magnets, or any known connecting technology. Alternatively or additionally, in other embodiments, the second connection 125 may comprise additional mating elements. Alternatively or additionally, the connection 125 may be adapted to accept dispensing tips used with prior art pastry bags, for example by using an adapted threaded connection.

The tip 130 further comprises an end 135, whose configuration determines a predetermined shape when using the food dispensing device 10 when the user compresses the bag 110, the semi-solid food preparation flows throw the narrow opposite opening 107 of the bag 110, then through the connector 120 and the tip 130, and finally flows through the end 135 of the tip 130, giving the semi-solid food preparation a final forming before being dispensed.

The tip 130 may be made of any suitable material. In some embodiments, the tip 130 may be made of a relatively rigid material to provide strength and/or durability. In some embodiments, the tip 130 may be made of a relatively rigid plastic. In this embodiment, a material of the tip 130 is molded plastic. In other embodiments, the tip 130 may be made of a metal (e.g. copper, stainless steel, aluminum, silver, gold, etc.).

Any feature of any embodiment discussed herein may be combined with any feature of any other embodiment discussed herein in some examples of implementation.

Various embodiments and examples have been presented for the purpose of describing, but not limiting, the invention. Various modifications and enhancements will become apparent to those of ordinary skill in the art and are within the scope of the invention, which is defined by the appended claims.

I claim:

1. A re-usable food dispensing device, comprising:
a. a flexible bag for receiving a food preparation;
b. a rigid connector permanently secured to the bag, the connector having an aperture therein defining a food preparation discharge pathway allowing the food preparation in the bag to be expressed through the connector, the flexible bag and the rigid connector secured to each other being re-usable and configurated to be cleanable after the food preparation is dispensed to remove food preparation residue in order to make the flexible bag and the rigid connector suitable for receiving a new food preparation;
c. a dispensing tip releasably mounted to the connector, the dispensing tip including a discharge nozzle configured to impart a pre-determined shape to the food preparation that is expressed from the bag through the dispensing tip.

2. A food dispensing device as defined in claim 1, wherein the connector is co-molded with the flexible bag.

3. A food dispensing device as defined in claim 2, wherein the discharge pathway includes an annular recess configured for receiving an extremity of the flexible bag, the recess having a depth that generally matches a thickness of the flexible bag to provide a substantially smooth internal wall of the discharge pathway.

4. A food dispensing device as defined in claim 3, wherein the bag is tapered.

5. A food dispensing device as defined in claim 4, wherein the dispensing tip releasably connects to the connector via a bayonet connection.

6. A food dispensing device as defined in claim 4, wherein the dispensing tip releasably connects to the connector via a threaded connection.

7. A food dispensing device as defined in claim 4, wherein the bag is made of silicone.

8. A food dispensing device as defined in claim 7, wherein the connector is made of plastic material compatible with silicone to be co-molded therewith.

9. A re-usable food dispensing device, comprising:
a. a flexible bag having an upper end portion and an opposite lower end portion, the flexible bag tapering from the upper end portion to the lower end portion, the flexible bag configured for receiving a food preparation through the upper end portion;
b. a rigid connector permanently secured to the lower end portion, the connector including an internal tubular passage having a recessed portion therein receiving the lower end portion of the bag, the recessed portion having a depth substantially corresponding to a thickness of the bag to provide a food preparation discharge pathway extending from an inside of the bag to an extremity of the connector and having a substantially smooth walls;
c. a dispensing tip releasably mounted to the connector, the dispensing tip including a discharge nozzle configured to impart a pre-determined shape to the food preparation that is expressed from the bag through the dispensing tip.

10. A food dispensing device as defined in claim 9, wherein the connector is co-molded with the flexible bag.

11. A food dispensing device as defined in claim 10, wherein the dispensing tip releasably connects to the connector via a bayonet connection.

12. A food dispensing device as defined in claim 10, wherein the dispensing tip releasably connects to the connector via a threaded connection.

13. A food dispensing device as defined in claim 10, wherein the bag is made of silicone.

14. A food dispensing device as defined in claim 13, wherein the connector is made of plastic material compatible with silicone to be co-molded therewith.
